(19) United States
(12) Patent Application Publication
(10) Pub. No.: US 2016/0243649 A1
(43) Pub. Date: Aug. 25, 2016

(54) OPTICAL SYSTEM FOR 3D PRINTING AND CONTROL METHOD THEREOF

(71) Applicant: Guangzhou Institute of Advanced Technology, Chinise Academy of Sciences, Guangzhou City, Guangdong (CN)

(72) Inventors: Zhu ZHENG, Guangzhou City, Guangdong (CN); Olaf EICHSTAEDT, Guangzhou City, Guangdong (CN); Yunpeng REN, Guangzhou City, Guangdong (CN); Ruxu DU, Guangzhou City, Guangdong (CN)

(21) Appl. No.: 14/762,333

(22) PCT Filed: Jul. 17, 2014
(86) PCT No.: PCT/CN2014/082414

§ 371 Date: Jul. 21, 2015

(30) Foreign Application Priority Data
Jul. 10, 2014 (CN) 201410328198.6

(51) Int. Cl. B23K 26/342; B23K 26/06; B28B 17/00; B23K 26/067; B29C 67/00; B28B 1/00

(52) U.S. Cl. CPC B23K 26/342; B29C 67/0088; B28B 1/001; B28B 17/0063; B23K 26/067; B23K 26/0648; B29K 2105/251

(57) ABSTRACT

The present invention discloses an optical system for 3D printing and a control method thereof. The system comprises a laser device, a beam expanding system, a beam splitter, a spatial light modulator and a focusing system. The spatial light modulator is connected with a computer and configured to generate a modulation pattern after receiving the target modulation pattern generated by the computer. A light beam emitted by the laser device is expanded into a parallel light beam by the beam expanding system and then irradiates on the beam splitter. A part of the expanded light beam reaches the spatial light modulator for modulation after passing through the beam splitter, then the modulated light beam is reflected to the beam splitter, and a part of the modulated light beam is focused by the focusing system and then irradiates on a target plane for 3D printing.

### FIELD OF THE INVENTION

The present invention relates to the field of 3D printing, in particular to an optical system for 3D printing and a control method thereof.

### BACKGROUND OF THE INVENTION

Due to its ability to directly actualize a digital model, the 3D printing technology may change conventional designs and manufacturing methods. At present, the 3D printing has been applied in aerospace, medical treatment, automobiles and other many fields. However, the industrial popularization and application of the 3D printing technology still have many problems, a key problem of which is slow printing speed. All existing 3D printing devices, including Selective Laser Sintering (SLS), Selective Laser Melting (SLM) or the like, depend on point-by-point and layer-by-layer printing using a single beam or multiple beams of laser, and the movement of the focus of a light beam is controlled by a reflector and a lens combination both controlled by a micro electromechanical system so as to realize point-by-point printing. This printing mode is slow in speed and low in efficiency, so it becomes a bottleneck of the development of 3D printing technology at present.

### SUMMARY OF THE INVENTION

To solve the above technical problem, an objective of the present invention is to provide an optical system for 3D printing, and another objective of the present invention is to provide a control method of an optical system for 3D printing.

To solve the technical problem, the present invention employs the following technical solutions.

An optical system for 3D printing is provided, including a laser device, a beam expanding system, a beam splitter, a spatial light modulator and a focusing system, wherein the spatial light modulator is connected with a computer for generating a target modulation pattern and configured to generate a modulation pattern after receiving the target modulation pattern generated by the computer; a light beam emitted by the laser device is expanded into a parallel light beam having a large diameter by the beam expanding system and then irradiates on the beam splitter; a part of the expanded light beam reaches the spatial light modulator for modulation after passing through the beam splitter, then the modulated light beam is reflected to the beam splitter, and a part of the modulated light beam is focused by the focusing system and then irradiates on a target plane for 3D printing.

Further, the beam expanding system includes a negative lens and a positive lens, the axis of the negative lens and the axis of the positive lens being on a same line, the light beam emitted by the laser device being expanded into a parallel light beam having a large diameter by successively passing the negative lens and the positive lens.

Further, the spatial light modulator is a reflector type digital micromirror device, and the focusing system is a cylindrical lens.

Further, the spatial light modulator is a phase type liquid crystal spatial light modulator, and the focusing system is a positive lens.

A control method of an optical system for 3D printing is provided, including:

step 1: after acquiring a planar pattern of each plane of a printing model for 3D printing by a computer, generating a target modulation pattern from the acquired planar pattern and sending the target modulation pattern to the spatial light modulator; and

step 2: expanding a light beam emitted by the laser device into a parallel light beam having a large diameter by the beam expanding system and then allowing the light beam to irradiate on the beam splitter, allowing a part of the expanded light beam to reach the spatial light modulator for modulation after passing through the beam splitter, and allowing a part of the modulated light to be focused by the focusing system and then irradiate on a target plane for 3D printing after the modulated light is reflected to the beam splitter.

Further, in step 2, the expanding a light beam emitted by the laser device into a parallel light beam having a large diameter by the beam expanding system specifically is:

expanding the light beam emitted by the laser device into a parallel having a large diameter successively by a negative lens and a positive lens.

Further, the spatial light modulator is a reflector type digital micromirror device, the focusing system is a cylindrical lens, and step 1 specifically is:

after acquiring a planar pattern of each plane of a printing model for 3D printing by a computer, segmenting the acquired planar pattern into a plurality of line segment patterns having a same width, and successively sending the acquired line segment patterns as target modulation patterns to the reflector type digital micromirror device.

Further, the control method of an optical system for 3D printing further includes:

step 3: successively printing, by a 3D printing system, in an order of the successively focused line segment patterns, and moving the 3D printing system or the optical system in a same direction according to the width of the line segment patterns once one line segment pattern is printed.

Further, the spatial light modulator is a phase type liquid crystal spatial light modulator, the focusing system is a positive lens, and step 1 specifically is:

after acquiring a planar pattern of each plane of a printing model for 3D printing by a computer, generating a phase-only hologram according to the following steps from the acquired planar pattern and then sending the phase-only hologram as a target modulation pattern to the phase type liquid crystal spatial light modulator;

step 11: forming an incident wave function ƒₙ(u,v) according to the following formula and on the basis of an initial phase distribution φ₀(u,v) of the planar pattern and the amplitude |U(u,v)| of incident light incident on the phase type liquid crystal spatial light modulator:

ƒₙ(u,v)=|U(u,v)|·e^{iφ}^{₀}^{(u,v)};

step 12: performing Fourier transformation to the incident wave function ƒₙ(u,v):

gₙ(x,y)=|Gₙ(x,y)|·e^{iψ}^{ₙ},

where gₙ(x,y) denotes the Fourier transformation of the incident wave function ƒₙ(u,v);

step 13: replacing Gₙ(x,y) with an expectantly modulated amplitude Gₙ(x,y) to obtain an intermediate function gₙ′(x,y):

gₙ′(x,y)=|G(x,y)|·e^{iψ}^{ₙ};

step 14: performing inverse Fourier transformation to the intermediate function gₙ′(x,y):

ƒₙ′(u,v)|Uₙ(u,v)|·e^{iφ}^{ₙ}^{(u,v)},

where ƒₙ′(u,v) denotes the inverse Fourier transformation of the intermediate function gₙ′(x,y);

step 15: generating an incident wave function ƒₙ₊₁(u,v) of the next iteration according to the phase e^{iφ}^{ₙ}^{(u,v)} of the inverse Fourier transformation of the intermediate function gₙ′(x,y) and the amplitude |U(u,v)| of the incident light:

ƒₙ₊₁(u,v)=|U(u,v)|·e^{iφ}^{ₙ}^{(u,v)}; and

step 16: repeating the above steps until a convergence condition is satisfied, and using the inverse Fourier transformation of the intermediate function gₙ′(x,y) at this moment as a phase-only hologram of the planar pattern.

The present invention has the following beneficial effects: the present invention provides an optical system for 3D printing, including a laser device, a beam expanding system, a beam splitter, a spatial light modulator and a focusing system, wherein the spatial light modulator is connected with a computer for generating a target modulation pattern and configured to generate a modulation pattern after receiving the target modulation pattern generated by the computer. In the optical system, the target modulation pattern is generated by a computer and then sent to the spatial light modulator to generate a modulation pattern, so that the light beam is focused onto a target plane for 3D printing after modulated. Compared with the point-by-point focusing in the prior art, the optical system performs optical modulation and focusing demodulation in unit of modulation pattern, may realize line-by-line printing, segment-by-segment printing and even whole-plane printing, greatly improves the printing efficiency of the 3D printing system, and meanwhile ensures the high quality of 3D printing.

The present invention has the following other beneficial effects: the present invention provides a control method of an optical system for 3D printing, including: after acquiring a planar pattern of each plane of a printing model for 3D printing by a computer, generating a target modulation pattern from the acquired planar pattern and sending the target modulation pattern to the spatial light modulator; and, expanding a light beam emitted by the laser device into a parallel light beam having a large diameter by the beam expanding system and then allowing the light beam to irradiate on the beam splitter, allowing a part of the expanded light beam to reach the spatial light modulator for modulation after passing through the beam splitter, and allowing a part of the modulated light to be focused by the focusing system and then irradiate on a target plane for 3D printing after the modulated light is reflected to the beam splitter. In the control method, the target modulation pattern is generated by a planar pattern of a printing model for 3D printing and then sent to the spatial light modulator to generate a modulation pattern, so that the light beam is focused onto a target plane for 3D printing after modulated. Compared with the point-by-point focusing control method in the prior art, the control method performs optical modulation and focusing demodulation in units of modulation patterns. When applied in a 3D printing system, the control method may greatly improve the printing efficiency of the 3D printing system and ensure the accuracy of printing.

### BRIEF DESCRIPTION OF THE DRAWINGS

The present invention will be further described as below with reference to accompanying drawings by embodiments.

FIG. 1 is a structural block diagram of an optical system for 3D printing according to the present invention;

FIG. 2 is a structural block diagram of Embodiment 3 of the present invention;

FIG. 3 is a schematic diagram of a target modulation pattern according to Embodiment 4 of the present invention;

FIG. 4 is a schematic diagram of a modulation pattern and a printing pattern obtained after focusing according to Embodiment 4 of the present invention;

FIG. 5 is a principle diagram of the modulation and demodulation of a planar pattern for 3D printing according to Embodiment 5 of the present invention;

FIG. 6 is a schematic diagram of a scanning process of point-by-point printing in the prior art;

FIG. 7 is a schematic diagram of a scanning process of line-by-line printing in a control method according to the present invention; and

FIG. 8 is a schematic diagram of a scanning process of segment-by-segment printing in a control method according to the present invention.

### DETAILED DESCRIPTION OF THE EMBODIMENTS

Explanations of terms used in the invention are given below, for the convenience and understanding of the description.

DMD: Digital MicroMirror Device, which may realize any light or dark pattern.

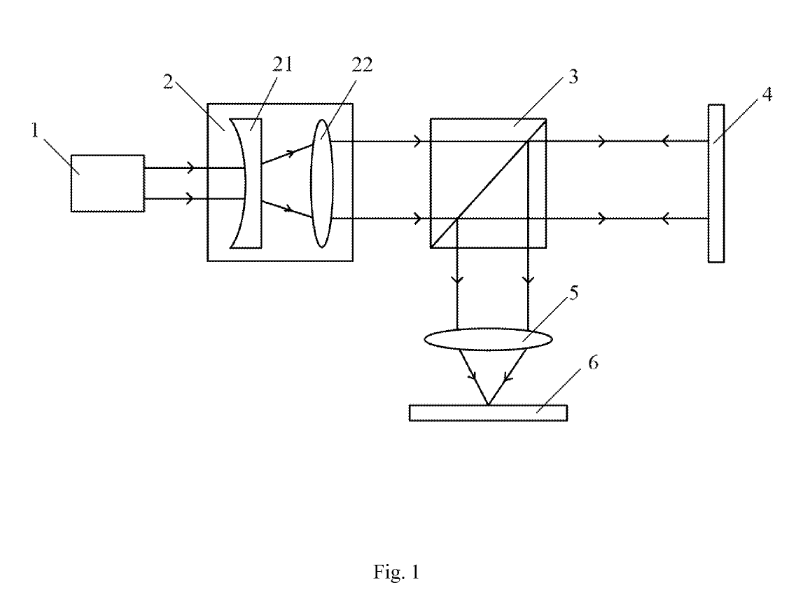

Referring to FIG. 1, the present invention provides an optical system for 3D printing, including a laser device 1, a beam expanding system 2, a beam splitter 3, a spatial light modulator 4 and a focusing system 5. The spatial light modulator 4 is connected with a computer for generating a target modulation pattern and configured to generate a modulation pattern after receiving the target modulation pattern generated by the computer. A light beam emitted by the laser device 1 is expanded into a parallel light beam having a large diameter by the beam expanding system 2 and then irradiates on the beam splitter 3. A part of the expanded light beam reaches the spatial light modulator 4 for modulation after passing through the beam splitter 3, then the modulated light beam is reflected to the beam splitter 3, and a part of the modulated light beam is focused by the focusing system 5 and then irradiates on a target plane 6 for 3D printing.

Further, as a preferred implementation, the beam expanding system 2 comprises a negative lens 21 and a positive lens 22, with the axis of the negative lens 21 and the axis of the positive lens 22 being on a same line, and the light beam emitted by the laser device 1 is expanded into a parallel light beam having a large diameter successively by the negative lens 21 and the positive lens 22.

Further, as a preferred implementation, the spatial light modulator 4 is a reflector type digital micromirror device, and the focusing system is a cylindrical lens.

Further, as a preferred implementation, the spatial light modulator 4 is a phase type liquid crystal spatial light modulator, and the focusing system is a positive lens.

A control method of an optical system for 3D printing is provided, including:

step 1: after acquiring a planar pattern of each plane of a printing model for 3D printing by a computer, generating a target modulation pattern from the acquired planar pattern and sending the target modulation pattern to the spatial light modulator 4; and

step 2: expanding a light beam emitted by the laser device 1 into a parallel light beam having a large diameter by the beam expanding system 2 and then allowing the light beam to irradiate on the beam splitter 3, allowing a part of the expanded light beam to reach the spatial light modulator 4 for modulation after passing through the beam splitter 3, and allowing a part of the modulated light to be focused by the focusing system 5 and then irradiate on a target plane 6 for 3D printing after the modulated light is reflected to the beam splitter 3.

Further, as a preferred implementation, in step 2, the expanding a light beam emitted by the laser device 1 into a parallel light beam having a large diameter by the beam expanding system 2 specifically is:

expanding the light beam emitted by the laser device 1 into a parallel having a large diameter successively by a negative lens 21 and a positive lens 22.

Further, as a preferred implementation, the spatial light modulator 4 is a reflector type digital micromirror device, the focusing system 5 is a cylindrical lens, and step 1 specifically is:

after acquiring a planar pattern of each plane of a printing model for 3D printing by a computer, segmenting the acquired planar pattern into a plurality of line segment patterns having a same width, and successively sending the acquired line segment patterns as a target modulation pattern to the reflector type digital micromirror device.

Further, as a preferred implementation, the control method of an optical system for 3D printing further includes:

step 3: successively printing, by a 3D printing system, in an order of the successively focused line segment patterns, and moving the 3D printing system or the optical system in a same direction according to the width of the line segment patterns once one line segment pattern is printed.

Further, as a preferred implementation, the spatial light modulator 4 is a phase type liquid crystal spatial light modulator, the focusing system is a positive lens, and step 1 specifically is:

after acquiring a planar pattern of each plane of a printing model for 3D printing by a computer, generating a phase-only hologram according to the following steps from the acquired planar pattern and then sending the phase-only hologram as a target modulation pattern to the phase type liquid crystal spatial light modulator;

step 11: forming an incident wave function ƒₙ(u,v) according to the following formula and on the basis of an initial phase distribution φ₀(u,v) of the planar pattern and the amplitude |U(u,v)| of incident light incident on the phase type liquid crystal spatial light modulator:

ƒₙ(u,v)=|U(u,v)|·e^{iφ}^{₀}^{(u,v)};

step 12: performing Fourier transformation to the incident wave function ƒₙ(u,v):

gₙ(x,y)=|Gₙ(x,y)|·e^{iψ}^{ₙ},

where gₙ(x,y) denotes the Fourier transformation of the incident wave function ƒₙ(u,v);

step 13: replacing Gₙ(x,y) with an expectantly modulated amplitude G(x,y) to obtain an intermediate function gₙ′(x,y):

gₙ′(x,y)=|G(x,y)|·e^{iφ}^{ₙ};

step 14: performing inverse Fourier transformation to the intermediate function gₙ′(x,y):

ƒₙ′(u,v)|Uₙ(u,v)|·e^{iφ}^{ₙ}^{(u,v)},

where ƒₙ′(u,v) denotes the inverse Fourier transformation of the intermediate function gₙ′(x,y);

step 15: generating an incident wave function ƒₙ₊₁(u,v) of the next iteration according to the phase e^{iφ}^{ₙ}^{(u,v)} of the inverse Fourier transformation of the intermediate function gₙ′(x,y) and the amplitude |U(u,v)| of the incident light:

ƒₙ₊₁(u,v)=|U(u,v)|·e^{iφ}^{ₙ}^{(u,v)}; and

step 16: repeating the above steps until a convergence condition is satisfied, and using the inverse Fourier transformation of the intermediate function gₙ′(x,y) at this moment as a phase-only hologram of the planar pattern.

The present invention will be further described below by specific implementations.

### Embodiment 1

Referring to FIG. 1, an optical system for 3D printing is provided, including a laser device 1, a beam expanding system 2, a beam splitter 3, a spatial light modulator 4 and a focusing system 5. The spatial light modulator 4 is connected with a computer for generating a target modulation pattern and configured to generate a modulation pattern after receiving the target modulation pattern generated by the computer, and configured to modulate a light beam that irradiates on the spatial light modulator 4. A light beam emitted by the laser device 1 is expanded into a parallel light beam having a large diameter by the beam expanding system and then irradiates on the beam splitter 3. A part of the expanded light beam reaches the spatial light modulator 4 for modulation after passing through the beam splitter 3, then the modulated light beam is reflected to the beam splitter 3, and a part of the modulated light beam is focused by the focusing system 5 and then irradiates on a target plane 6 for 3D printing.

In this embodiment, the beam expanding system 2 includes a negative lens 21 and a positive lens 22, with the axis of the negative lens 21 and the axis of the positive lens 22 being on a same line. The light beam emitted by the laser device 1 is expanded into a parallel light beam having a large diameter successively by the negative lens 21 and the positive lens 22. The axis of the negative lens 21 and the axis of the positive lens 22 being on a same line actually means that the axis of the negative lens 21 and the optical axis of the positive lens 22 are on a same line. It is to be noted that, the centers of all the laser device 1, the negative lens 2, the positive lens 22, the beam splitter 3 and the spatial light modulator 4 are on a same line such that the optical system can work more efficiently. When a light beam irradiates on the beam splitter 3, one half transmits the beam splitter 3, while the other half is reflected. When the light beam in the optical system initially irradiates on the beam splitter 3, the light beam transmitting through the beam splitter 3 is utilized. When the reflected light beam after modulated by and from the spatial light modulator 4 returns to the beam splitter 3, the light beam reflected via the light beam 3 is utilized.

The spatial light modulator 4 is a reflector type digital micromirror device, and the focusing system is a cylindrical lens. In this embodiment, one-dimensional or two-dimensional modulation is carried out by the reflector type digital micromirror device, and then the modulated light beam is focused into line segments by the cylindrical lens and then irradiates on the target plane 6 for 3D printing.

Generally, the target plane 6 for 3D printing is provided on a working platform of a 3D printing system and is movable in a three-dimensional direction. Therefore, after focusing to the target plane 6 by using the optical system, the 3D printing system performs 3D printing and meanwhile the working platform may be controlled to move, so as to update the target plane 6 and perform the next modulation, focusing and printing. Alternatively, once the printing is finished, the optical system is moved to focus a new target plane 6.

### Embodiment 2

Referring to FIG. 1, an optical system for 3D printing is provided, including a laser device 1, a beam expanding system 2, a beam splitter 3, a spatial light modulator 4 and a focusing system 5. The spatial light modulator 4 is connected with a computer for generating a target modulation pattern, and configured to generate a modulation pattern after receiving the target modulation pattern generated by the computer, and configured to modulate a light beam that irradiates on the spatial light modulator 4. A light beam emitted by the laser device 1 is expanded into a parallel light beam having a large diameter by the beam expanding system and then irradiates on the beam splitter 3. A part of the expanded light beam reaches the spatial light modulator 4 for modulation after passing through the beam splitter 3, then the modulated light beam is reflected to the beam splitter 3, and a part of the modulated light beam is focused by the focusing system 5 and then irradiates on a target plane 6 for 3D printing.

In this embodiment, the beam expanding system 2 includes a negative lens 21 and a positive lens 22, with the axis of the negative lens 21 and the axis of the positive lens 22 being on a same line. The light beam emitted by the laser device 1 is expanded into a parallel light beam having a large diameter successively by the negative lens 21 and the positive lens 22. The axis of the negative lens 21 and the axis of the positive lens 22 being on a same line actually means that the axis of the negative lens 21 and the optical axis of the positive lens 22 are on a same line. It is to be noted that, the centers of all the laser device 1, the negative lens 2, the positive lens 22, the beam splitter 3 and the spatial light modulator 4 are on a same line such that the optical system can work more efficiently. When a light beam irradiates on the beam splitter 3, one half transmits the beam splitter, while the other half is reflected. When the light beam in the optical system irradiates on the beam splitter 3 for the first time, the light beam transmitting through the beam splitter 3 is utilized. When the reflected light beam after modulated by the spatial light modulator 4 returns to the beam splitter 3, the light beam reflected via the light beam 3 is utilized.

The structure of the optical system in Embodiment 1 is basically the same as that in Embodiment 2, except for a difference: the spatial light modulator 4 is a phase type liquid crystal spatial light modulator, and the focusing system is a positive lens. In this embodiment, phase modulation is performed by the phase type liquid crystal spatial light modulator, and then the modulated light beam is focused by the positive lens so as to reestablish a plane pattern for 3D printing and irradiate on a target plane 6 for 3D printing.

Similar to Embodiment 1, the target plane 6 for 3D printing is provided on a working platform of a 3D printing system and is movable in a three-dimensional direction. Therefore, after focusing to the target plane 6 by using the optical system, the 3D printing system performs 3D printing and meanwhile the working platform may be controlled to move, so as to update the target plane 6 and perform the next modulation, focusing and printing. Alternatively, once the printing is finished, the optical system is moved to focus a new target plane 6.

### Embodiment 3

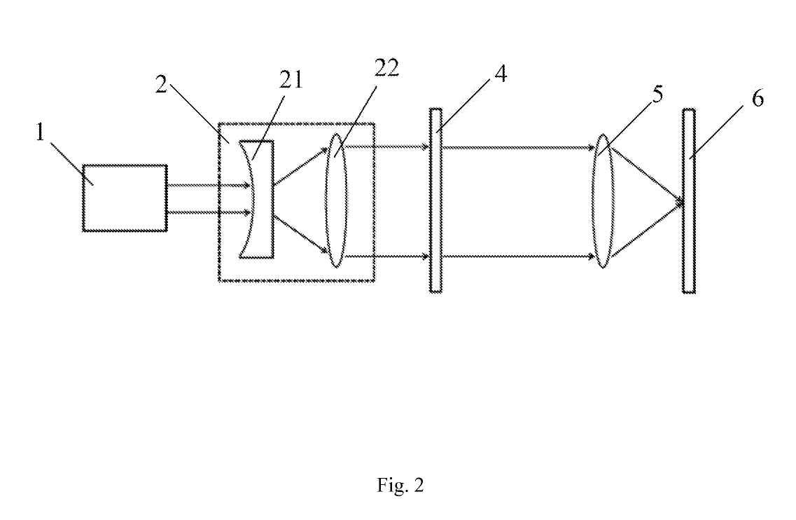

Referring to FIG. 2, an optical system for 3D printing is provided, including a laser device 1, a beam expanding system 2, a spatial light modulator 4 and a focusing system 5. The spatial light modulator 4 is connected with a computer for generating a target modulation pattern and configured to generate a modulation pattern after receiving the target modulation pattern generated by the computer, and configured to modulate a light beam that irradiates on the spatial light modulator 4. A light beam emitted by the laser device 1 is expanded into a parallel light beam having a large diameter by the beam expanding system and then irradiates on the spatial light modulator 4 for modulation, and then the modulated light beam is focused by the focusing system 5 and then irradiates on a target plane 6 for 3D printing.

In this embodiment, the beam expanding system 2 includes a negative lens 21 and a positive lens 22, with the axis of the negative lens 21 and the axis of the positive lens 22 being on a same line. The light beam emitted by the laser device 1 is expanded into a parallel light beam having a large diameter successively by the negative lens 21 and the positive lens 22.

This embodiment is a simplification of the optical structure in FIG. 1. Without a beam splitter 3, the expanded light beam is directly modulated and then focused on the target plane 6. There are two combinations for the spatial light modulation 4 and the focusing system 5: first, the spatial light modulator 4 is a transmission type DMD, and the focusing system 5 is a cylindrical lens; second, the spatial light modulator 4 is a phase type liquid crystal spatial light modulator, and the focusing system is a positive lens. The working principle of this embodiment is similar to that in the forgoing embodiments.

### Embodiment 4

This embodiment is a control method of the optical system for 3D printing in Embodiment 1, including the following steps.

Step 1: After a planar pattern of each plane of a printing model for 3D printing is acquired by a computer, the acquired planar pattern is segmented into a plurality of line segment patterns having a same width, and the acquired line segment patterns as a target modulation pattern are successively sent to the reflector type digital micromirror device.

Step 2: A light beam emitted by the laser device 1 is expanded into a parallel light beam having a large diameter by the negative lens 21 and the positive lens 22 and then irradiates on the beam splitter 3; a part of the expanded light beam reaches the reflector type digital micromirror device for modulation after passing through the beam splitter 3, and a part of the modulated light is focused by the cylindrical lens and then irradiates on a target plane 6 for 3D printing after the modulated light is reflected to the beam splitter 3.

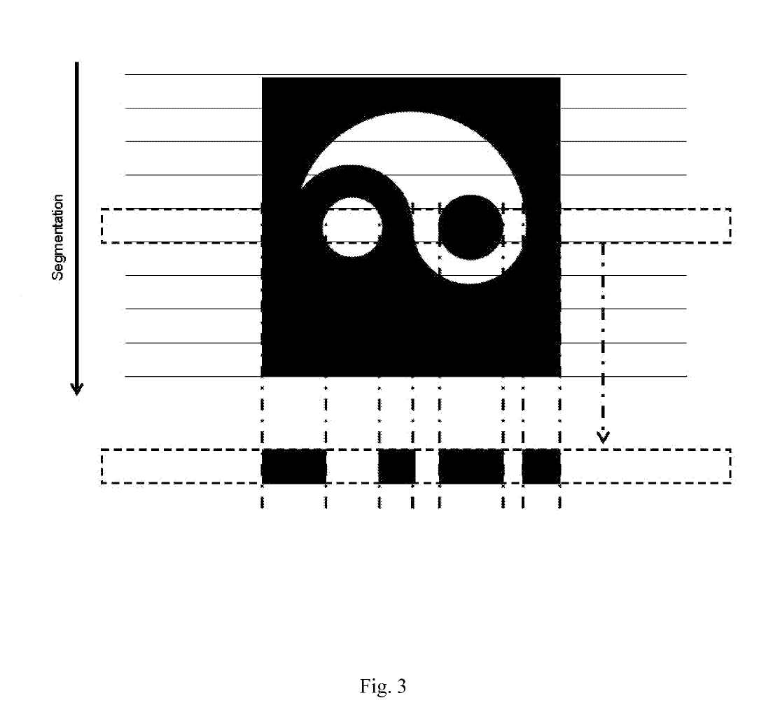

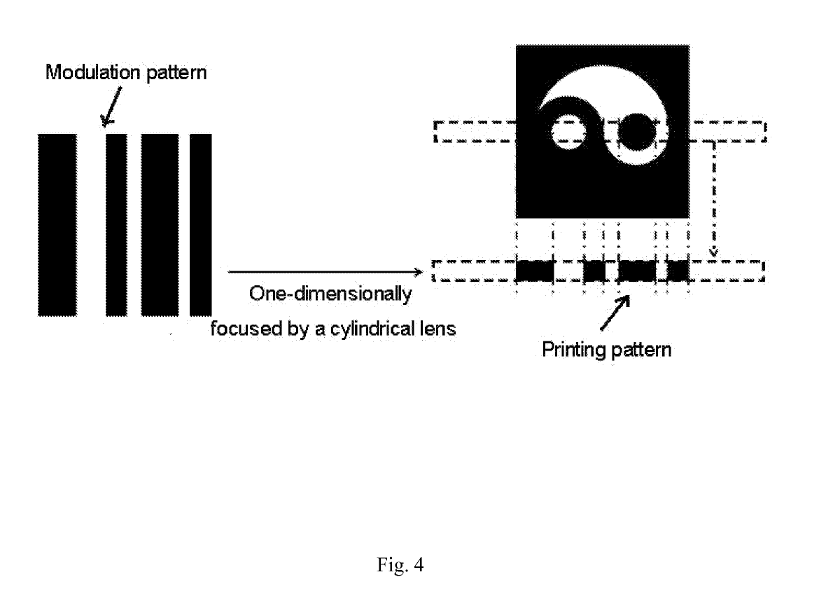

As shown in FIG. 3, the target modulation patterns received by the reflector type digital micromirror device are line segment patterns obtained by segmenting in FIG. 3 as shown by a lower part of FIG. 3, so the modulation patterns generated by the reflector type digital micromirror device are stripes corresponding to the target modulation patterns, as shown in FIG. 4. When a light beam irradiates on the reflector type digital micromirror device, the reflector type digital micromirror device loads stripes corresponding to the target modulation patterns on the light beam, i.e., modulates the light beam. The modulated light beam is reflected to the beam splitter 3, and a part of the modulated light beam is reflected by the light beam 3, then one-dimensionally focused into a printing pattern identical to the target modulation pattern by the cylindrical lens and irradiates on the target plane 6 for 3D printing. FIG. 4 visually describes a process of focusing the modulation pattern to obtain a printing pattern by the cylindrical lens.

Step 3: Printing is successively performed by a 3D printing system in an order of the successively focused line segment patterns, and the 3D printing system or the optical system is moved in a same direction according to the width of the line segment patterns once one line segment pattern is printed. Here, the movement distance of the 3D printing system or optical system is equal to the width of the target modulation pattern. Because the target modulation pattern in this embodiment is line segment patterns, the movement distance is equal to the width of the line segment patterns. In addition, the moving a 3D printing system mentioned herein generally is moving a working platform of the 3D printing system.

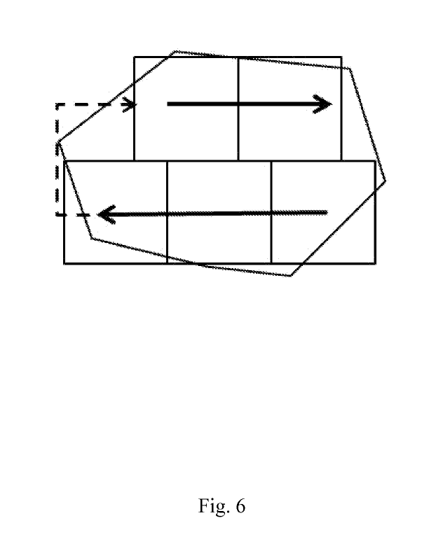

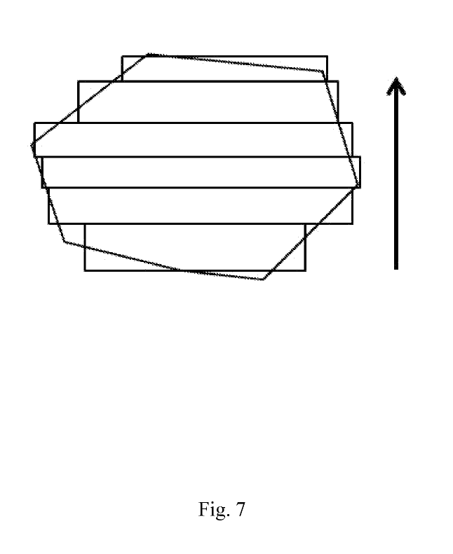

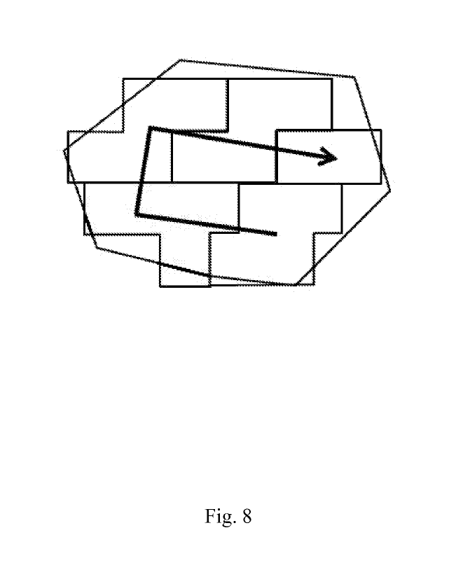

In this embodiment, after the planar pattern of each plane of the printing model for 3D printing is segmented into a plurality of line segment patterns having a same width, the light beam is modulated by the reflector type digital micromirror device in unit of line segment pattern and then focused to a target plane for 3D printing, thereby assisting the 3D printing system to perform printing segment by segment. In this embodiment, the printing segment by segment may employ printing line by line or printing segment by segment. FIG. 6 is a schematic diagram of a scanning process of point-by-point printing in the prior art, FIG. 7 is a schematic diagram of a scanning process of line-by-line printing in the control method provided by this embodiment, and FIG. 8 is a schematic diagram of a scanning process of segment-by-segment printing in the control method provided by this embodiment. It can be seen from FIGS. 6-8 that, in comparison to the point-by-point printing in the prior art, the control method provided by the present invention greatly improves the printing efficiency of 3D printing. In addition, a smaller width of the line segment patterns is better. When the width is smaller, the resolution of the 3D printing is higher, the printing effect is better, and the quality of 3D printed products may be thus ensured.

### Embodiment 5

This embodiment is a control method of the optical system for 3D printing in Embodiment 2, including the following steps.

Step 1: After a planar pattern of each plane of a printing model for 3D printing is acquired by a computer, a phase-only hologram of the planar pattern is generated according to the following steps from the acquired planar pattern, and then the phase-only hologram as a target modulation pattern is sent to the phase type liquid crystal spatial light modulator.

Step 11: An incident wave function ƒₙ(u,v) is formed according to the following formula and on the basis of an initial phase distribution φ₀(u,v) of the planar pattern and the amplitude |U(u,v)| of incident light incident on the phase type liquid crystal spatial light modulator:

ƒₙ(u,v)=|U(u,v)|·e^{iφ}^{₀}^{(u,v)}.

Step 12: Fourier transformation is performed to the incident wave function ƒₙ(u,v):

gₙ(x,y)=|Gₙ(x,y)|·e^{iψ}^{ₙ}.

where gₙ(x,y) denotes the Fourier transformation of the incident wave function ƒₙ(u,v).

Step 13: Gₙ(x,y) replaced with an expectantly modulated amplitude G(x,y) to obtain an intermediate function gₙ′(x,y):

Step 14: Inverse Fourier transformation is performed to the intermediate function gₙ′(x,y):

ƒₙ′(u,v)|Uₙ(u,v)|·e^{iφ}^{ₙ}^{(u,v)},

where ƒₙ′(u,v) denotes the inverse Fourier transformation of the intermediate function gₙ′(x,y).

Step 15: An incident wave function ƒₙ₊₁(u,v) of the next iteration is generated according to the phase e^{iφ}^{ₙ}^{(u,v)} of the inverse Fourier transformation of the intermediate function gₙ′(x,y) and the amplitude |U(u,v)| of the incident light:

ƒₙ₊₁(u,v)=|U(u,v)|·e^{iφ}^{ₙ}^{(u,v)}.

Step 16: The above steps are repeated until a convergence condition is satisfied, and the inverse Fourier transformation of the intermediate function gₙ′(x,y) at this moment is used as a phase-only hologram of the planar pattern.

The convergence condition may be set as the number of times of iterative calculation or be determined according to a certain threshold or signal-to-noise ratio, which will not be described in details here.

Step 2: A light beam emitted by the laser device 1 is expanded into a parallel light beam having a large diameter by the negative lens 21 and the positive lens 22 and then irradiates on the beam splitter 3; a part of the expanded light beam reaches the reflector type digital micromirror device for modulation after passing through the beam splitter 3, and a part of the modulated light is focused by the cylindrical lens and then irradiates on a target plane 6 for 3D printing after the modulated light is reflected to the beam splitter 3.

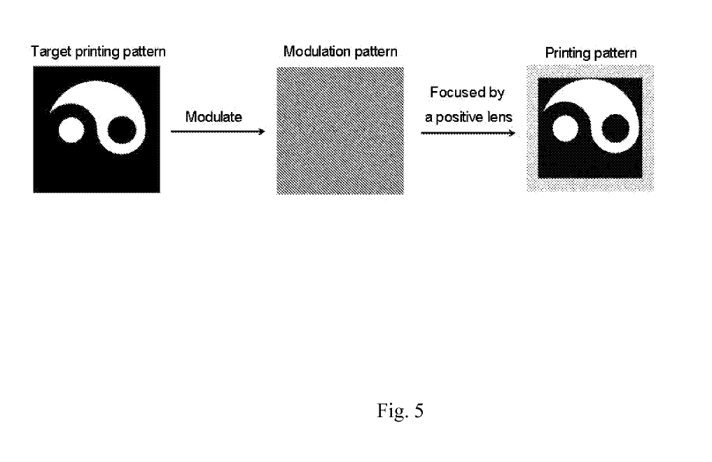

FIG. 5 is a principle diagram of the modulation and demodulation of the planar pattern for 3D printing in this embodiment. After the computer generates a phase-only hologram shown by a middle part of FIG. 5 from the acquired planar pattern shown by the left side of FIG. 5, the phase-only hologram is sent to the phase type liquid crystal spatial light modulator. After receiving the target modulation pattern, the phase type liquid crystal spatial light modulator generates a modulation pattern identical to the phase-only hologram so as to modulate the light beam which irradiates thereon. The modulated light beam is reflected to the beam splitter 3, and a part of the modulated light beam is reflected by the beam splitter 3, then focused into a printing pattern (shown by the right side of FIG. 5) identical to the target modulation pattern by the cylindrical lens and irradiates on the target plane 6 for 3D printing.

In this embodiment, using a phase type liquid crystal spatial light modulator to perform phase modulation may minimize the loss of the energy of the light beam.

In this embodiment, a phase-only hologram of the planar pattern is generated from the planar pattern of each plane of a printing model for 3D printing and then used as a target modulation pattern. Then, the light beam is modulated by a phase type liquid crystal spatial light modulator in unit of planar pattern and then focused on a target plane for 3D printing, thereby assisting the 3D printing system to perform printing plane by plane. Compared with the point-to-point printing in the prior art, the control method provided by the present invention greatly improve printing efficiency; meanwhile, the control method may perform printing in unit of plane, so the accuracy of printing may be effectively controlled and the efficiency and quality of 3D printing are greatly improved.

The control method for the optical system in FIG. 2 is similar to that in Embodiment 4 or 5, except for a difference that the optical system directly modulates the expanded light beam and directly focuses the modulated light beam.

Although the preferred embodiments of the present invention have been specifically described, the present invention is not limited thereto. Various equivalent variations or replacements may be made by those skilled in the art without departing from the spirit of the present invention, and those various equivalent variations or replacements shall fall into the scope defined by the appended claims of the present application.

1. An optical system for 3D printing, comprising a laser device (1), a beam expanding system (2), a beam splitter (3), a spatial light modulator (4) and a focusing system (5), characterized in that the spatial light modulator (4) is connected with a computer for generating a target modulation pattern and configured to generate a modulation pattern after receiving the target modulation pattern generated by the computer; a light beam emitted by the laser device (1) is expanded into a parallel light beam having a large diameter by the beam expanding system (2) and then irradiates on the beam splitter (3); a part of the expanded light beam reaches the spatial light modulator (4) for modulation after passing through the beam splitter (3), then the modulated light beam is reflected to the beam splitter (3), and a part of the modulated light beam is focused by the focusing system (5) and then irradiates on a target plane (6) for 3D printing.

2. The optical system for 3D printing according to claim 1, characterized in that the beam expanding system (2) comprises a negative lens (21) and a positive lens (22), the axis of the negative lens (21) and the axis of the positive lens (22) being on a same line, the light beam emitted by the laser device (1) being expanded into a parallel light beam having a large diameter successively by the negative lens (21) and the positive lens (22).

3. The optical system for 3D printing according to claim 1, characterized in that the spatial light modulator (4) is a reflector type digital micromirror device, and the focusing system is a cylindrical lens.

4. The optical system for 3D printing according to claim 1, characterized in that the spatial light modulator (4) is a phase type liquid crystal spatial light modulator, and the focusing system is a positive lens.

5. A control method of the optical system for 3D printing according to claim 1, comprising:
step 1: after acquiring a planar pattern of each plane of a printing model for 3D printing by a computer, generating a target modulation pattern from the acquired planar pattern and sending the target modulation pattern to the spatial light modulator (4); and
step 2: expanding a light beam emitted by the laser device (1) into a parallel light beam having a large diameter by the beam expanding system (2) and then allowing the light beam to irradiate on the beam splitter (3), allowing a part of the expanded light beam to reach the spatial light modulator (4) for modulation after passing through the beam splitter (3), and allowing a part of the modulated light to be focused by the focusing system (5) and then irradiate on a target plane (6) for 3D printing after the modulated light is reflected to the beam splitter (3).

6. The control method of an optical system for 3D printing according to claim 5, characterized in that, in step 2, the expanding a light beam emitted by the laser device (1) into a parallel light beam having a large diameter by the beam expanding system (2) specifically is:
expanding the light beam emitted by the laser device (1) into a parallel having a large diameter successively by a negative lens (21) and a positive lens (22).

7. The control method of an optical system for 3D printing according to claim 5, characterized in that the spatial light modulator (4) is a reflector type digital micromirror device, the focusing system is a cylindrical lens and step 1 specifically is:
after acquiring a planar pattern of each plane of a printing model for 3D printing by a computer, segmenting the acquired planar pattern into a plurality of line segment patterns having a same width, and successively sending the acquired line segment patterns as a target modulation pattern to the reflector type digital micromirror device.

8. The control method of an optical system for 3D printing according to claim 7, further comprising:
step 3: successively printing, by a 3D printing system, in an order of the successively focused line segment patterns, and moving the 3D printing system or the optical system in a same direction according to the width of the line segment patterns once one line segment pattern is printed.

9. The control method of an optical system for 3D printing according to claim 5, characterized in that the spatial light modulator (4) is a phase type liquid crystal spatial light modulator, the focusing system is a positive lens, and step 1 specifically is:
after acquiring a planar pattern of each plane of a printing model for 3D printing by a computer, generating a phase-only hologram according to the following steps from the acquired planar pattern and then sending the phase-only hologram as a target modulation pattern to the phase type liquid crystal spatial light modulator;
step 11: forming an incident wave function ƒₙ(u,v) according to the following formula and on the basis of an initial phase distribution φ₀(u,v) of the planar pattern and the amplitude |U(u,v)| of incident light incident on the phase type liquid crystal spatial light modulator:
ƒₙ(u,v)=|U(u,v)|·e^{iφ}^{₀}^{(u,v)};
step 12: performing Fourier transformation to the incident wave function ƒₙ(u,v):
gₙ(x,y)=|Gₙ(x,y)|·e^{iφ}^{ₙ},
where gₙ(x,y) denotes the Fourier transformation of the incident wave function ƒₙ(u,v);
step 13: replacing Gₙ(x,y) with an expectantly modulated amplitude G(x,y) to obtain an intermediate function gₙ′(x,y):
gₙ′(x,y)=|G(x,y)|·e^{iψ}^{ₙ};
step 14: performing inverse Fourier transformation to the intermediate function gₙ′(x,y):
ƒₙ′(u,v)|Uₙ(u,v)|·e^{iφ}^{ₙ}^{(u,v)},
where ƒₙ′(u,v) denotes the inverse Fourier transformation of the intermediate function gₙ′(x,y);
step 15: generating an incident wave function ƒₙ₊₁(u,v) of the next iteration according to the phase e^{iφ}^{ₙ}^{(u,v)} of the inverse Fourier transformation of the intermediate function gₙ′(x,y) and the amplitude |U(u,v)| of the incident light:
ƒₙ₊₁(u,v)=|U(u,v)|·e^{iφ}^{ₙ}^{(u,v)}; and
step 16: repeating the above steps until a convergence condition is satisfied, and using the inverse Fourier transformation of the intermediate function gₙ′(x,y) at this moment as a phase-only hologram of the planar pattern.
